(19) United States
(12) Patent Application Publication
(10) Pub. No.: US 2009/0139104 A1
(43) Pub. Date: Jun. 4, 2009

(54) MULTI-PIECE FRAMING SQUARE

(76) Inventor: Barry L. Rohweder, Minneapolis, MN (US)

Correspondence Address: James J. Paige, Esq.;NIKOLAI & MERSEREAU, P.A., Suite 820, 900 Second Avenue South, Minneapolis, MN, 55402-3813, US

(21) Appl. No.: 11/948,055

(22) Filed: Nov. 30, 2007

(51) Int. Cl. B43L 7/10

(52) U.S. Cl. 33/478; 29/592

(57) ABSTRACT

In some embodiments, a multi-piece frame square may include one or more of the following features: (a) a first arm, (b) a second arm, (c) a lever capable of being received by a slot within the second arm, (d) a retention portion releasably coupled to receiver slots on the first arm and receiver slots on the lever, (e) a receiver notch at a proximal end of the first arm, (f) catch portions on the second arm for receiving the lever, and (g) receiver holes on the first arm to receive alignment pins located on the second arm.

### FIELD OF THE INVENTION

Embodiments of the present invention relate generally to workmen's tools. Particularly, embodiments of the present invention relate to a carpenter's square. More particularly embodiments of the present invention relate to a carpenter's square having separate arm members rigidly joined to one another for use and easily separated for ease of storage.

### BACKGROUND

In carpentry, a square or set square is a guide for establishing right angles (90° angles), and is in the shape of a right triangle. A carpenter's square is a tool carpenters and other tradesmen use. The carpenter's square is commonly referred to as a framing square. It consists of a large arm and a smaller arm, which meet at an angle of 90 degrees (a right angle). It can also be made of metals like aluminum, which is light and resistant to rust.

The wider arm, two inches wide, is called the blade; the narrower arm, one and one-half inches wide, the tongue. The square has many uses, including laying out common rafters, hip rafters and stairs. It has a diagonal scale, board foot scale, and an octagonal scale. On the newer framing squares there are degree conversions for different pitches and fractional equivalents.

The prior art is replete with examples of carpenter's squares having separable or folding arms for ease of carrying, but for the most part, they suffer from a number of different drawbacks, not the least of which is the inability to quickly and rigidly join and separate the tool arms of the square without resorting to additional tools. When it is recognized one arm of a typical carpenter's square may be as long as 22½ inches and the other 16 inches, any play in the joint between the two arms can translate into a relatively large possible angular deviation from perpendicular the end of the arm opposite the joint.

Some carpenter's squares have an arrangement where the arms of the square are undercut at their junction and screws are used to fasten the arms together. This arrangement requires a screwdriver to fasten the two arms together and unless the screws are tightened down snugly, there is an opportunity for play in the joint.

Some carpenter's squares have one blade with a terminal portion adapted to fit into a dove-tail groove formed in the other arm. Unless the tongue and groove arrangement is formed with very tight tolerances, the resulting play will result in a significant deviation of the opposite end of one arm from the perpendicular. Moreover, in use, wear in the tongue and groove joint will compound the problem.

Some carpenter's squares have a tongue which is inserted in a groove defined by arms for interlocking. Screws are then employed to more rigidly affix the halves of the square to one another.

Some carpenter's squares have a square arrangement where the arms join along a diagonal, the two arms being undercut at the joint so each arm is of half the thickness of the remaining portion of the arms in the location of the joint. A rack and pinion gear arrangement cooperating with a slide plate is provided for holding the two parts together. A hook-like end on the slide plate fits into a slot formed in the adjacent arm and the slide plate bridges the joint. Again, a screwdriver must be used to rotate the pinion to first create a snug coupling and later used to release the two arms. Any play in the rack and pinion gear arrangement necessarily results in undue play between the mating arms of the square.

It would be desirable to have a multi-piece framing square with at least one of the following qualities:
having little to no play in the joint between the two arms to prevent possible angular deviation from perpendicular;

having minimal parts and assembly;

no screws to fasten the two arms together;

no tongue and groove assembly; and

no rack and pinion coupling engagement.

### SUMMARY OF THE INVENTION

In some embodiments, a multi-piece frame square may include one or more of the following features: (a) a first arm, (b) a second arm, (c) a lever capable of being received by a slot within the second arm, (d) a retention portion releasably coupled to receiver slots on the first arm and receiver slots on the lever, (e) a receiver notch at a proximal end of the first arm, (f) catch portions on the second arm for receiving the lever, and (g) receiver holes on the first arm to receive alignment pins located on the second arm.

In some embodiments, a separable carpenter's square may include one or more of the following features: (a) a first elongated rectangular arm member having receiver holes formed at a proximal end and a receiver notch formed through a thickness dimension thereof intermediate the receiver holes, (b) a second elongated rectangular arm member having alignment pins projecting outwardly and adapted to be received in the receiver holes of the first arm member, the second arm member having a slot formed inwardly between the alignment pins, (c) a lever mounted in the slot of the second arm member with a retention portion releasably clamping the lever to the first arm to hold the first and second arm members to one another, (d) support pins located at a proximal and distal end of the retention portion, and (e) lever legs coupled to the lever.

In some embodiments, a method of manufacturing a multi-piece framing square may include one or more of the following steps: (a) creating a first arm, (b) creating a second arm, (c) creating a retention portion for coupling the first arm and the second arm together, and (d) creating a lever capable of coupling to the retention portion.

### DESCRIPTION OF THE DRAWINGS

FIG. 1A is a plan view of a multi-piece carpenter's square in embodiments of the present invention;

FIG. 1B is an exploded plan view of a multi-piece carpenter's square in embodiment of the present invention;

FIG. 2 is an oblique shortened view in a joined condition of a multi-piece carpenter's square in embodiments of the present invention;

FIG. 3 is an oblique shortened view in unlatched condition of a multi-piece carpenter's square in embodiments of the present invention;

FIG. 4 is an expanded oblique shortened view of a multi-piece carpenter's square in embodiments of the present invention;

FIG. 5 shows a process diagram of a manufacturing process to create a multi-piece carpenter's square in embodiments of the present invention.

### DESCRIPTION OF THE PREFERRED EMBODIMENT

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments of the present invention provide a separable carpenter's square having first and second arms being readily coupled and uncoupled without the use of any extra tools and which will provide a rigid joint between the two arms so as to prevent any play therebetween translating into inaccurate alignment of work pieces intended to meet at a right angle.

Embodiments of the present invention broadly provide an improved carpenter's square separated into multiple components for ease of carrying in a toolbox and readily rigidly joined to one another for use without any need to resort to the use of other tools to effect the inter-coupling thereof.

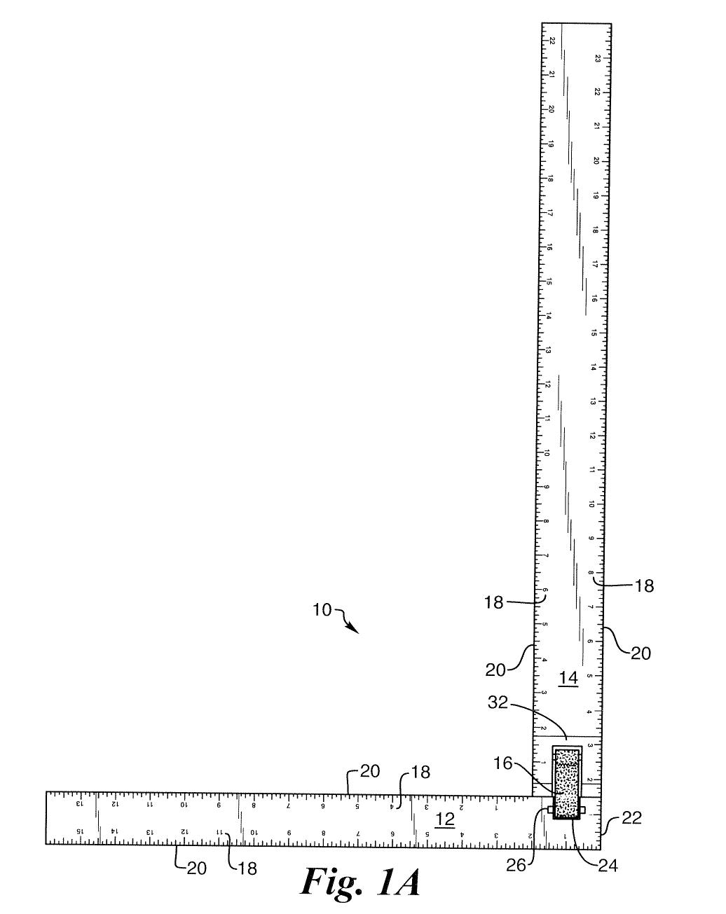

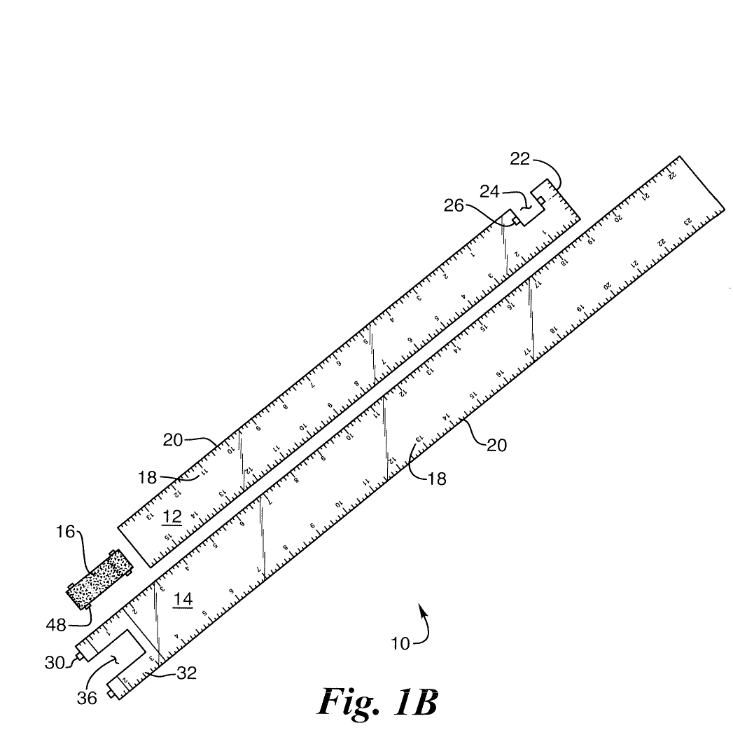

With reference to FIGS. 1A and 1B, a plan view of a multi-piece carpenter's square in embodiments of the present invention is shown. There is indicated generally by numeral 10, a carpenter's square having an elongated rectangular first arm 12 member, an elongated rectangular second arm member 14, and retention portion 16. Longer arm 14 may be 22½ inches in length and have a width of 2 inches. Shorter arm 12 may typically be 16 inches in length and 1½ inches wide. Arm members 12 and 14 may be fabricated from most any type of material, such as metal or plastic, and have conventional measuring indicia 18 scribed along the longitudinal edges of the upper and lower major surfaces. Retention portion 16 can be made of most any flexible material, such as rubber, without departing from the spirit of the invention. Retention part 16 can be 2½ inches by ½ inches with both length and width being variable due to the retention part's flexibility.

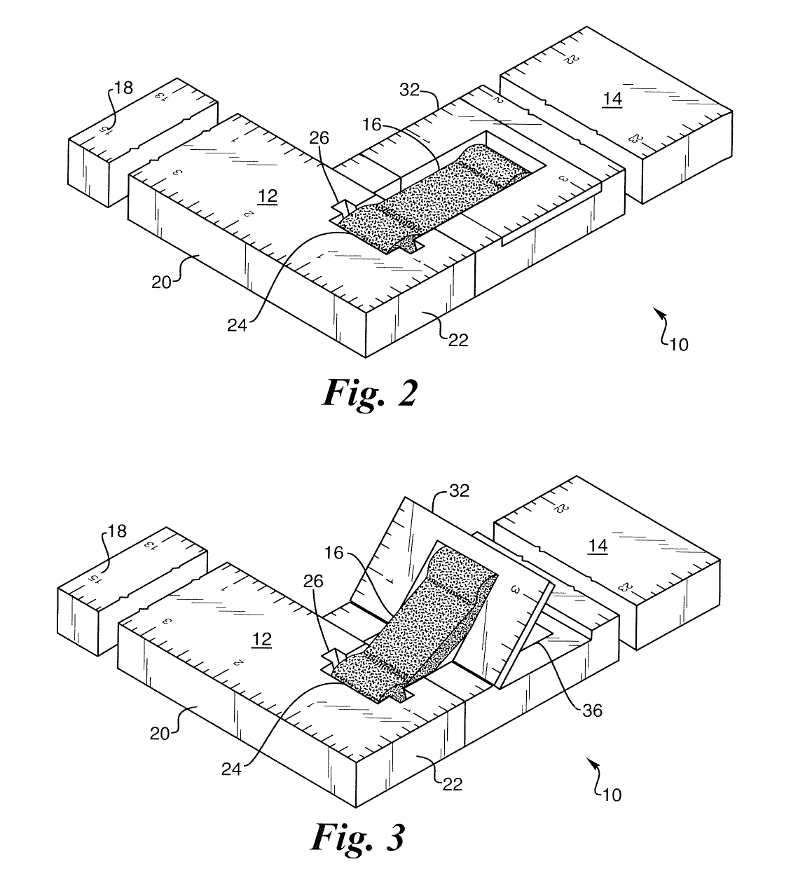

With reference to FIG. 2, an oblique shortened view in joined condition of a multi-piece carpenter's square in embodiments of the present invention is shown. Shorter arm 12 can have conventional measuring indicia 18 along the edges 20. Located at proximal end 22 is a receiver notch 24 for receiving retention portion 16, as will be discussed in more detail below. Receiver notch 24 can have receiver slots 26 and receiver holes 28 (FIG. 4), both for alignment and retention of longer arm 14.

With reference to FIG. 3, an oblique shortened view in unlatched condition of a multi-piece carpenter's square in embodiments of the present invention is shown. Longer arm 14 can have alignment pins 30 (FIG. 4) and lever 32 which can rotate between a latched and unlatched position. Lever 32 can be received by slot 36 where lever legs 38 rest against semi-circle catch portions 39.

Retention portion 16 has a middle portion 42, proximal end 44, distal end 46, and support pins 48. Retention portion 16 can be made of rubber; however, retention portion 16 can be made of almost any elastic material without departing from the spirit of the invention. Retention portion 16 could be made of a resilient material to withstand repeated stretching apart and contraction back, as will be discussed in more detail below.

With reference to FIGS. 1A-4, views of a multi-piece carpenter's square in embodiments of the present invention are shown. When a user desires to use multi-piece carpenter's square 10, they would simply need to spend a few moments assembling carpenter's square 10. In operation, the user could place support pins 48 on distal end 46 of retention portion 16 within respective receiver slots 26 on shorter arm 12. The user could then mate alignment pins 30 with receiver holes 28 thus temporarily connecting long arm 14 with short arm 12. Support pins 48 on proximal end 44 of retention portion 16 can then be placed within receiver slots 34 on lever 32 while lever 32 is in the unlatched position as shown in FIG. 3. The user can now push lever 32 downward towards long arm 14 to place lever 32 in a latched position. As lever 32 moves towards a latched position, retention portion 16 becomes stretched as support pins 48 on proximal end 44 and distal end 46 are pulled further apart due to the greater distance between receiver slots 26 and receiver slots 34. Once lever 32 is in the latched position, enough tension is created in retention portion 16 to hold short arm 12 and long arm 14 tightly together. It is further contemplated the amount of tension could be adjusted by lengthening or shortening the length of retention portion 16.

When the user is ready to put framing square 10 away, they would simply lift lever 32 into the unlatched position, remove support pins 48 from receiver slot 34, remove support pins 48 from receiver slot 26, and place long arm 14, short arm 12, and retention portion 16 away, compactly, in a space, such as a toolbox.

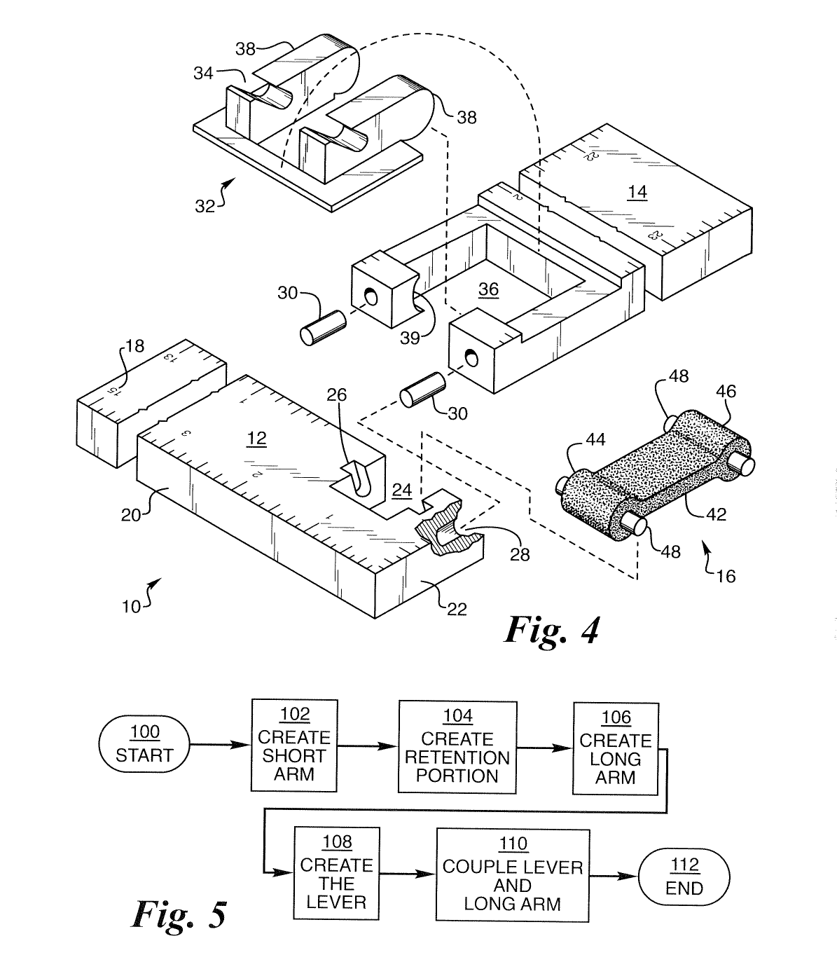

With reference to FIG. 5, a process diagram of a manufacturing process to create a multi-piece carpenter's square in embodiments of the present invention is shown. To manufacture a multi-piece carpenter's square 10, a process 100 as shown in FIG. 5 could be used. A short arm 12 could be fabricated or cut having a receiver notch 24 and receiver slots 26 at state 102. A retention portion 16 could be fabricated at state 104. A long arm 14 could be fabricated capable of receiving a lever 32 and having alignment pins 30 at state 106. A lever 32 could be fabricated at state 108. At state 110 lever 32 could be coupled to long arm 14 using pins 36. Multi-piece carpenter's square 10 could now be ready for assembly.

Thus, embodiments of the MULTI-PIECE FRAMING SQUARE are disclosed. One skilled in the art will appreciate the present teachings can be practiced with embodiments other than those disclosed. The disclosed embodiments are presented for purposes of illustration and not limitation, and the present teachings are limited only by the following claims.

What is claimed is:

1. A multi-piece framing square, comprising:
a first arm;
a second arm;
a lever capable of being received by a slot within the second arm; and
a retention portion releasably coupled to receiver slots on the first arm and receiver slots on the lever.

2. The framing square of claim 1, wherein the second arm is longer than the first arm.

3. The framing square of claim 2, wherein the second arm is wider than the first arm.

4. The framing square of claim 1, further comprising a receiver notch at a proximal end of the first arm.

5. The framing square of claim 4, wherein the receiver notch includes the receiver slots.

6. The framing square of claim 1, further comprising catch portions on the second arm for receiving the lever.

7. The framing square of claim 1, further comprising receiver holes on the first arm to receive alignment pins located on the second arm.

8. A separable carpenter's square, comprising:
a first elongated rectangular arm member having receiver holes formed at a proximal end and a receiver notch formed through a thickness dimension thereof intermediate the receiver holes;
a second elongated rectangular arm member having alignment pins projecting outwardly and adapted to be received in the receiver holes of the first arm member, the second arm member having a slot formed inwardly between the alignment pins; and
a lever mounted in the slot of the second arm member with a retention portion releasably clamping the lever to the first arm to hold the first and second arm members to one another.

9. The carpenter's square of claim 8, wherein the retention portion is comprised of a flexible material.

10. The carpenter's square of claim 8, further comprising support pins located at a proximal and distal end of the retention portion.

11. The carpenter's square of claim 9, wherein the retention portion is comprised of rubber.

12. The carpenter's square of claim 8, further comprising lever legs coupled to the lever.

13. The carpenter's square of claim 12, wherein the lever legs rest against catch portions when the lever is in a latched position.

14. A method of manufacturing a multi-piece framing square, comprising the steps of:
creating a first arm;
creating a second arm;
creating a retention portion for coupling the first arm and the second arm together; and
creating a lever capable of coupling to the retention portion.

15. The method of claim 14, wherein the first arm is an elongated arm with a receiving notch having receiving slots within.

16. The method of claim 14, wherein the second arm is larger than the first arm.

17. The method of claim 14, wherein the retention portion is made of a flexible material.

18. The method of claim 15, wherein the first arm has receiver holes located adjacent to the receiving notch.

19. The method of claim 18, wherein the second arm has alignment pins located adjacent a slot.

20. The method of claim 19, wherein the alignment pins can be received by the receiver holes.
